(19) United States
(12) Patent Application Publication
(10) Pub. No.: US 2026/0073544 A1
(43) Pub. Date: Mar. 12, 2026

(54) CONTEXTUALLY CONSISTENT DEPTH MAP

(71) Applicant: QUALCOMM Incorporated, San Diego, CA (US)

(72) Inventors: Shubhankar Mangesh BORSE, San Diego, CA (US); Varun RAVI KUMAR, San Diego, CA (US); Senthil Kumar YOGAMANI, San Diego, CA (US)

(21) Appl. No.: 18/884,029

(22) Filed: Sep. 12, 2024

(51) Int. Cl. G06T 7/593; G06N 3/0455; G06V 10/70

(52) U.S. Cl. CPC G06T 7/593; G06N 3/0455; G06V 10/70; G06T 2207/10028

(57) ABSTRACT

Certain aspects of the present disclosure provide techniques for generating a contextualized depth map. Techniques may include encoding a depth map into a latent representation, applying a contextual embedding to the latent representation to obtain a contextualized latent representation, and decoding the contextualized latent representation into the contextualized depth map.

### FIELD OF THE DISCLOSURE

Aspects of the present disclosure relate to depth estimation, and more particularly, to techniques for generating depth maps.

### DESCRIPTION OF RELATED ART

Depth estimation in computer vision technologies aims to infer a three-dimensional structure of a scene from data, where the data may often be captured in two-dimensions, such as two-dimensional images. Depth maps, which represent the distance of each pixel from a sensor, such as an image sensor of a camera, are widely used in various applications such as autonomous driving, robotics, augmented reality, and 3D reconstruction. Accurate depth information enables systems to understand and interact with their surroundings more effectively.

Traditional depth estimation methods often rely on stereo vision, where depth is calculated by triangulating corresponding points in multiple views of the scene. However, stereo-based approaches may require specialized hardware setups and can struggle with textureless or occluded regions. In some aspects, textureless regions refer to areas in an image that have little or no variation in intensity or color, making it difficult to identify unique features for depth estimation. An example of a textureless region may include a white wall within a scene. In some aspects, occluded regions refer to areas that are partially or fully hidden from view by other objects in a scene, leading to incomplete depth information. An example of an occluded region may include a truck that at last partially blocked by another vehicle or tree. Monocular depth estimation, which aims to predict depth from a single image (e.g., also referred to as a frame, such as of sequence of frames that make up a video), has gained attention as a more flexible and cost-effective alternative. The resulting depth map may represent the depth information for objects in the frame, such that the depth map corresponds to the frame.

However, depth maps generated from a single frame often suffer from inconsistencies and inaccuracies due to the inherent ambiguity of the task. In some aspects, inconsistencies may refer to variations or contradictions in the predicted depth values across different regions of the same frame or between consecutive frames. For example, an object might be assigned different depth values in different parts of the image or appear to change depth abruptly between frames. In some aspects, inaccuracies may refer to the deviation of the predicted depth from the true depth of the scene, potentially leading to errors in the estimated 3D structure. The lack of temporal and/or spatial context can lead to depth estimates that are not coherent across frames, meaning that the depth values may not maintain a consistent and/or smooth transition between consecutive frames. Additionally, the performance of these methods can degrade in complex scenes with occlusions, reflections, or varying lighting conditions.

One issue with monocular depth estimation may be the presence of jitter or jerky artifacts in predicted depth maps. In some aspects, jitter refers to small and/or rapid variations in the estimated depth values between consecutive frames, causing the depth map to appear shaky or unstable. In some aspects, jerky artifacts may refer to more pronounced and abrupt changes in the depth values, resulting in a sudden shift or jump in the perceived depth of objects. This problem may arise when depth estimation is performed independently on each frame. The resulting depth maps can exhibit sudden changes and/or discontinuities between consecutive frames, leading to a visually unpleasant and inconsistent 3D representation of the scene. In some aspects, such changes and/or discontinuities may refer to abrupt shifts in depth values, causing a lack of smoothness in the temporal domain. Jitter can be particularly noticeable in applications such as augmented reality or 3D video rendering, where smooth and stable depth estimates may be used for downstream applications that create user experiences.

### SUMMARY

One aspect provides a method for generating a contextualized depth map. The method includes encoding a depth map into a latent representation, applying a contextual embedding to the latent representation to obtain a contextualized latent representation, and decoding the contextualized latent representation into the contextualized depth map.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example contextual depth map system for generating a contextualized depth map in accordance with aspects of the present disclosure.

FIG. 2 depicts an example system for generating a contextually consistent depth map in accordance with aspects of the present disclosure.

FIG. 3 depicts an example system for generating a contextually consistent depth map and a birds-eye view representation of a scene, in accordance with aspects of the present disclosure.

FIG. 4 depicts a training system for training a contextualized depth estimation model in accordance with aspects of the present disclosure.

FIG. 5 illustrates an example artificial intelligence (AI) architecture that may be used for generating a contextualized depth map.

FIG. 6 illustrates an example AI architecture of a first device that is in communication with a second device.

FIG. 7 illustrates an example artificial neural network.

FIG. 8 depicts an example method for generating a contextualized depth map in accordance with aspects of the present disclosure.

FIG. 9 depicts aspects of an example processing system in accordance with aspects of the present disclosure.

### DETAILED DESCRIPTION

Aspects of the present disclosure provide apparatuses, methods, processing systems, and computer-readable mediums for generating contextualized depth maps and/or for generating contextually consistent depth maps.

In some cases, accurate depth estimation and birds-eye view (BEV) segmentation are important aspects for autonomous vehicles to perceive and navigate their environment safely. However, existing approaches often face challenges in maintaining temporal consistency, adapting to dynamic scenes with varying motion patterns, and efficiently leveraging temporal context from previous frames. These limitations can result in artifacts, inaccurate depth predictions, and suboptimal BEV segmentation, compromising the reliability and performance of autonomous driving systems.

That is, existing depth map generation approaches often treat each frame, such as of a sequence of frames (e.g., of a video), independently without leveraging useful information, such as contextual information, from related frames over time. In some aspects, contextual information may refer to the spatial and temporal relationships between objects and scenes in adjacent frames. For example, the position, motion, and appearance of objects in previous frames can provide valuable cues for estimating depth in the current frame. In some aspects, by ignoring this contextual information, depth estimation methods may produce inconsistent results, where the estimated depth of an object varies significantly between frames, even if the frames may be close in proximity in time to one another. These limitations can result in a suboptimal depth estimation for one or more objects that can negatively impact downstream applications that rely on accurate 3D scene understanding.

For example, an issue with depth estimation from monocular frame sequences includes the presence of jitter or jerky artifacts in the predicted depth maps. This problem may arise when depth estimation is performed independently on each frame without considering the temporal context. The resulting depth maps can exhibit sudden changes or discontinuities between consecutive depth maps in time corresponding to consecutive frames in time, leading to a visually unpleasant and inconsistent 3D representation of the scene. Jitter can be particularly noticeable in applications such as augmented reality or 3D video rendering, where smooth and stable depth estimates are crucial for a compelling user experience.

Certain aspects of the present disclosure describe techniques to generate contextualized depth maps. In some aspects, a contextualized depth map may refer to a depth map that incorporates contextual information, such as spatial and/or temporal context, from multiple frames and/or from within a single frame, which may result in more consistent and accurate depth estimates. In some aspects, contextual information may refer to the additional knowledge and understanding of the relationships, dependencies, and dynamics within and/or between frames in a sequence of frames, such as a video. In some aspects, contextual information may include spatial context and temporal context of a scene. In some aspects, spatial context may refer to one or more relationships and dependences between objects within a frame, such as relative positions, sizes, and depths of objects. In some aspects, spatial context may capture the spatial arrangement and structure of a scene at a given time instance. In some aspects, temporal context may refer to one or more relationships and dependencies between objects across multiple frames, for example in a video sequence. In some aspects, temporal context may capture motion, dynamics, and evolution of objects over time, and may provide information about how a scene changes from one frame to another frame. By leveraging contextual information, techniques discussed herein may mitigate issues such as jitter, inconsistencies, and inaccuracies in predicted depth maps.

To generate a contextualized depth map, a depth map corresponding to a frame, for example a frame in a video, may be encoded into a latent representation using a machine learning model, such as a variational autoencoder (VAE), where a latent representation may refer to encoded features learned by the machine learning model (e.g., VAE) that capture one or more characteristics of the input, such as the frame. In some aspects, the latent representation may then be enhanced with contextual information by applying at least one of a temporal context embedding or a spatial context embedding to obtain a contextualized latent representation. In some aspects, a temporal context embedding may be an embedding of the temporal context, which may capture a temporal relationship between frames, such as the motion and appearance of objects over time, while a spatial context embedding may be an embedding of the spatial context, which may capture a spatial relationship of an object or between objects within a single frame, such as the relative positions and depths of objects.

In some aspects, the resulting contextualized latent representation, which may incorporate a spatial and/or temporal context, may then be decoded to generate a contextualized depth map. The contextualized depth map may have an improved depth estimate consistency and/or accuracy when compared to depth maps generated without considering contextual information.

In certain aspects, multiple contextualized depth maps may be aggregated, such as through a weighted summation, to produce a final contextually consistent depth map. In some aspects, a contextually consistent depth map may refer to a depth map that maintains consistency and coherence in the estimated depth values across multiple frames.

In some aspects, techniques discussed herein for generating contextualized depth maps provide a technical solution to the problem of inconsistent and inaccurate depth estimation from single frames. By encoding temporal and/or spatial context from multiple depth map frames into latent representations, some aspects of the techniques discussed herein may enable the generation of one or more depth maps having improved consistency and accuracy. In some aspects, improved consistency may be obtained by leveraging temporal context, which helps to maintain coherent depth estimates of objects across consecutive frames. For example, if a person is walking in a video, contextualized depth maps may maintain a consistent depth value for the person across frames, reducing jitter and sudden changes in depth. In some aspects, improved accuracy may be achieved by incorporating spatial context, which helps to refine the depth estimates based on the relationships between objects within a single frame. For example, if a chair is partially occluded by a table, the spatial context can help infer the correct depth of the chair based on its relative position to the table, resulting in a more accurate depth estimate.

In some aspects, the incorporation of temporal and/or spatial context can be used to generate more accurate and coherent depth maps. In some aspects, coherence refers to the consistency and smoothness of depth estimates across consecutive frames, ensuring that the depth values of objects change gradually and continuously over time. In some aspects, coherence is obtained by leveraging contextual cues, which may refer to one or more spatial and/or temporal relationships between one or more objects and one or more scenes in related frames. In some aspects, related frames may refer to adjacent frames in a sequence of frames, such as a video, that share similar content and provide information about the motion and/or the appearance of one or more objects. In some aspects, the contextual cues may be encoded and may be accessible in the latent representation during a depth map generation process.

In some aspects, the incorporation of temporal and/or spatial context enables additional visualization and/or analysis techniques, such as by generating and/or using one or more bird's-eye-view scene representations, which may be used to visualize and/or analyze 3D scene geometry. In some aspects, the incorporation of temporal and spatial context allows such techniques to better capture the 3D scene geometry over time by providing more accurate and more stable depth estimates. For example, in a bird's-eye-view representation of a street scene, improved depth maps may help to maintain consistent positioning and depths of vehicles and pedestrians across frames, resulting in a more accurate and smooth representation of the 3D scene geometry.

In some aspects, the techniques discussed herein for contextualized depth map generation utilize latent representations and contextual information to address the technical problem of suboptimal, inconsistent depth estimation in computer vision applications. As previously discussed, in some aspects, latent representations may refer to the encoded features learned by a machine learning model, such as a VAE, that capture characteristics of the input data. In some aspects, the latent representation and contextual information may be utilized by encoding the input depth maps into latent representations and then applying context embeddings to incorporate spatial and temporal context, where the context embeddings may refer to the learned representations that encode contextual information.

In some aspects, the utilization of temporal and/or spatial context in the depth map generation process may provide a technical solution for capturing 3D scene context, which may refer to the comprehensive spatial and temporal relationships between one or more objects and one or more scenes in input data, such as a frame and/or a plurality of frames. In certain aspects, the use of machine learning models enables the depth map generation techniques discussed herein to encode and utilize context in an adaptive manner rather than relying on predefined rules. In certain aspects, techniques discussed herein may be used in computer vision systems to improve depth estimation capability, and may enhance the performance of downstream applications such as 3D scene analysis and reconstruction and/or segmentation tasks utilizing BEV representations.

In some aspects, the present disclosure describes techniques to generate contextualized depth maps by encoding temporal and/or spatial context from multiple depth maps. In some aspects, the generated contextualized depth maps may then be aggregated into a contextually consistent depth map having a greater consistency and accuracy than any one of the depth maps prior.

### Aspects Related to Generating Contextualized Depth Maps

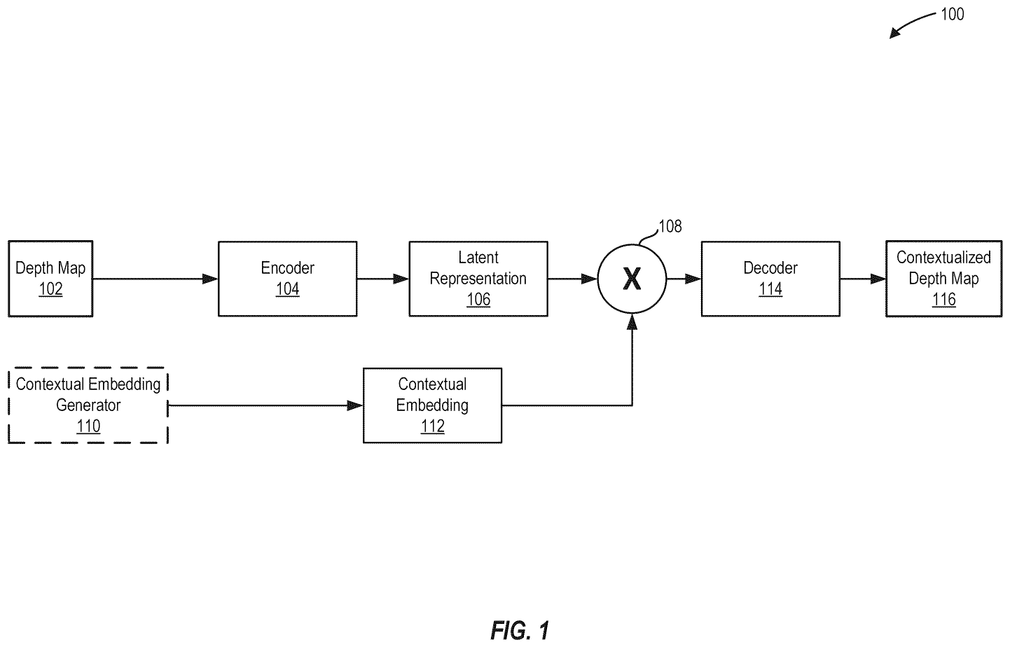

FIG. 1 depicts an example contextual depth map system 100 for generating a contextualized depth map 116 in accordance with aspects of the present disclosure. A contextualized depth map may be a depth map that is generated using contextual information to enhance the accuracy and/or consistency of one or more estimated depth values. In some aspects, the system 100 provides a framework for incorporating contextual information into the depth estimation process, which may then be used to increase accuracy and consistency of one or more estimated depth maps.

In some aspects, the system 100 may include an encoder 104 and a decoder 114, which together may be implemented as a variational autoencoder (VAE). A VAE may be a generative model that learns to encode input data, such as a depth map, into a lower-dimensional latent representation and then decode it to reconstruct an input, while regularizing the latent space to follow a prior distribution, such as a Gaussian distribution. In some aspects, the VAE may receive a depth map 102 as input and encode it into a latent representation 106. In some aspects, the depth map 102 represents a two-dimensional depth map containing information about the depth (e.g., distance) of one or more objects in a scene relative to a viewpoint (e.g., of a camera). For example, each coordinate (e.g., pixel) in the depth map 102 may correspond to a specific point in the scene and may include a value indicating the distance from the viewpoint to that point.

In some aspects, the latent representation 106 may be a lower-dimensional latent representation of the depth map 102. For example, the latent representation 106 may be a compressed representation of the depth map 102, capturing the underlying structure and semantics of the depth information.

In some aspects, the system 100 may include a contextual weighting mechanism 108 that combines the latent representation 106 with a contextual embedding 112 to obtain a contextualized latent representation. In some aspects, the contextual weighting mechanism 108 may generate one or more weights between the latent representation 106 and the contextual embedding 112, representing an importance and relevance of different parts of the contextual embedding with respect to each element of the latent representation. In some aspects, the one or more weights may be learned during training, allowing the contextual weighting mechanism 108 to adaptively focus on more informative contextual features for each depth map 102. In some aspects, the more informative contextual features may refer to those parts of the contextual embedding that provide more relevant and useful information for improving the depth estimation for a given depth map. In some aspects, contextual features may refer to elements or components of the contextual embedding that capture the spatial and temporal relationships within a scene. In some aspects, the contextual weighting mechanism 108 may comprise an attention mechanism, such as but not limited to self-attention, cross-attention, dot-product attention, and/or additive attention. For example where the contextual weighting mechanism 108 employs cross-attention, the queries for cross-attention may be provided from the latent representation 106 while the keys and values may be provided from the contextual embedding 112. Alternatively, or in addition, in some aspects, the contextual weighting mechanism 108 may include one or more of a learned pooling mechanism, gated mechanism, and/or parameterized aggregation mechanism.

In some aspects, the contextual embedding 112 may be generated by a contextual embedding generator 110, which may incorporate various types of contextual information to provide one or more cues for depth estimation. In some aspects, a contextual embedding may be a compact representation that encodes relevant contextual information, such as temporal context from one or more previous frames or one or more spatial relationships within a scene, to provide one or more additional cues for enhancing the depth estimation process. For example, the contextual embedding 112 may capture temporal context, one or more spatial relationships, or scene understanding, depending on the depth estimation task. In some aspects, scene understanding may refer to a high-level interpretation of the scene, including the recognition of objects, their relationships, and the overall context of the environment, which can be used during a depth estimation process.

In some aspects, to capture temporal context, the contextual embedding generator 110 may employ one or more techniques such as temporal convolutions or recurrent neural networks, to process one or more depth maps or one or more frames and extract relevant temporal features. In some aspects, temporal context may represent information about the motion and dynamics of one or more objects in the scene over time, address ambiguities (e.g., in cases of occlusions), and improve the consistency of the one or more estimated depth maps. For example, in a scene where a person is walking behind a tree, when the person is partially occluded by the tree, it may be challenging to estimate their depth accurately based on a single frame. However, by leveraging temporal context from previous frames, the system 100 can infer the person's depth based on their motion and position before and after the occlusion, thereby resolving the ambiguity. Similarly, in cases where an object is moving quickly or the scene has complex dynamics, temporal context can help maintain consistency in the estimated depth maps by considering the object's motion over time, rather than relying solely on the information from a single frame.

In some aspects, the contextual embedding 112 may be represented using a sinusoidal positional encoding, which may encode the temporal position or order of a depth map in a sequence of depth maps. In some aspects, a sinusoidal positional encoding allows the contextual weighting mechanism 108 to attend to specific time steps or positions based on their unique encoding patterns, thereby enabling the system 100 to capture temporal dependencies and relationships between depth maps.

For example, to estimate the depth map for a current frame at time t, denoted as \hat{d}ₜ, the contextual embedding generator 110 may take into account the time difference between the current frame and a previous frame at time t-i, where i represents a temporal offset. The contextual embedding 112 may be generated by encoding the time difference i using techniques such as sinusoidal positional encoding. This encoding allows the system 100 to capture the temporal relationship between the current frame and the frame at time t-i. The resulting contextual embedding 112 may then be used to modulate the latent representation 106 of the depth map, providing the system 100 with information about the temporal context of a depth map at time i given the depth at time t-i(dₜ₋ᵢ). In some aspects, to modulate the latent representation refers to combining the contextual embedding 112 with the latent representation 106 to adapt or modify it based on the temporal context. In some aspects, modulation can be achieved through various mechanisms, such as element-wise multiplication, addition, or a learned transformation, which allows the latent representation to incorporate the temporal information captured by the contextual embedding. By incorporating the time difference information into the contextual embedding 112, the system 100 can leverage the temporal dependencies to improve the accuracy and consistency of the estimated depth map for the current frame. In some aspects, the time difference i may be obtained by subtracting a timestamp associated with a depth map corresponding to a current frame from a timestamp associated with a depth map corresponding to a previous frame. In some aspects, the time difference i may be obtained as a difference of frame index positions.

In some aspects, the contextual embedding 112 may encode spatial relationships and scene understanding using techniques such as spatial convolutions or graph neural networks. Such techniques may be used to capture the relative positions, sizes, and/or arrangements of objects in a scene, as well as, in some cases, higher-level semantic information, providing cues for interpreting and refining the depth map 102.

In some aspects, the contextualized latent representation obtained from the contextual weighting mechanism 108 may be fed into the decoder 114. The decoder 114 may construct a contextualized depth map 116 based on the depth map 102 and the contextual embedding 112. In some aspects, the decoder 114 may be implemented as a deconvolutional neural network or a series of upsampling and convolutional layers, gradually increasing the spatial resolution of the representation to obtain the full-resolution depth map.

In some aspects, the output of the decoder 114 may be the contextualized depth map 116, which may represent the estimated depth information of the scene, enhanced by the contextual information. In some aspects, the contextualized depth map 116 may have the same spatial resolution as the input depth map 102 but with improved accuracy and/or consistency, as the depth map 102 captures the depth values of each pixel in the scene, but incorporates the contextual cues provided by the contextual embedding 112. In some aspects, the contextualized depth map 116 may be further processed or utilized in downstream tasks, such as 3D reconstruction, object detection, or autonomous navigation, where the enhanced depth information can improve the performance and reliability of these tasks.

### Aspects Related to Generating Contextually Consistent Depth Maps

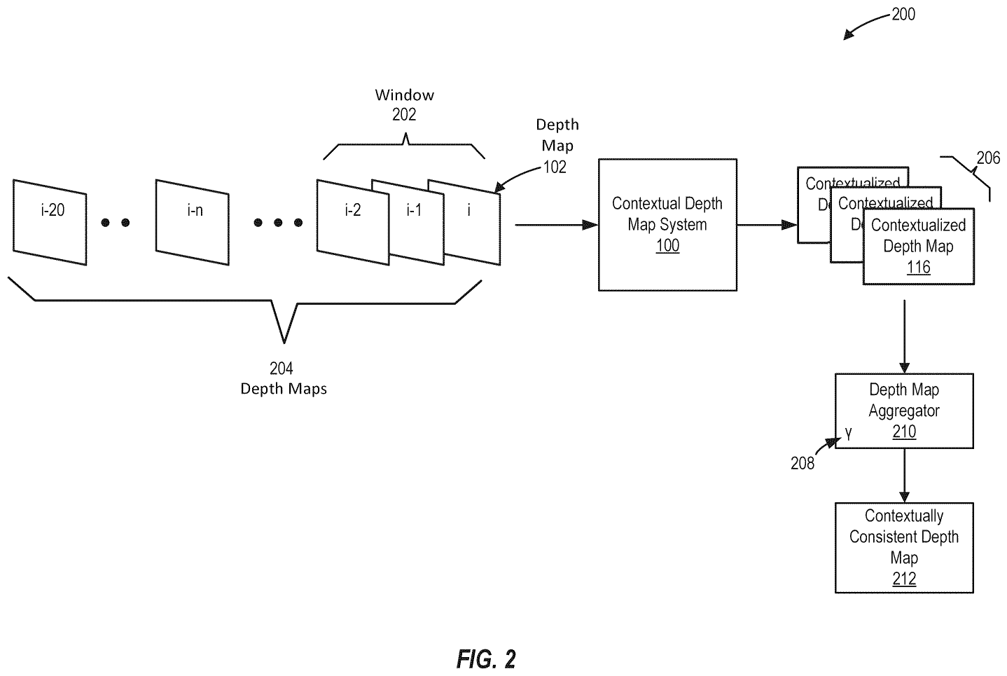

FIG. 2 depicts an example system 200 for generating a contextually consistent depth map 212 in accordance with aspects of the present disclosure. In some aspects, the system 200 utilizes the capabilities of the system 100 described in FIG. 1 by incorporating temporal context from a window 202 of depth maps 204 to increase the consistency and accuracy of the estimated depth information.

In some aspects, the window 202 may be a sliding window that includes a sequence of n previous depth maps 204 which may correspond to a sequence of frames, where n may be a predetermined number or dynamically adjusted based on a scene complexity or available computational resources. In some aspects, depth maps 204 represent a sequence of depth maps 102 obtained over time. In some aspects, the depth maps 204 may capture the scene structure at different time steps and provide the input for the contextual depth map system 100 to generate contextualized depth maps 116. In some aspects, the depth maps 204 within the window 202 provide temporal context for a current depth estimation task, allowing the system 200 to incorporate motion dynamics and scene variations over time.

In some aspects, the depth maps 204 from the window 202 may be processed by the contextual depth map system 100, as previously described with respect to FIG. 1. That is, for each depth map 102 in the window 202, the system 100 may generate a corresponding contextualized depth map 116. In certain aspects, the system 100 may encode each depth map 102 into a latent representation, apply a contextual embedding to the latent representation (where the contextual embedding may be different for each depth map 102 in the window 202), and decode the contextualized latent representation to obtain a respective contextualized depth map 116.

In some aspects, the plurality of contextualized depth maps 206 output by the system 100 may then be processed by a depth map aggregator 210 to generate a contextually consistent depth map 212. In some aspects, the depth map aggregator 210 may employ one or more of various techniques to combine the information from the plurality of contextualized depth maps 206, taking into account their temporal relationships and relevance to the current depth estimation task for example.

In some examples, the depth map aggregator 210 may assign one or more weights 208 to each contextualized depth map 116 of the plurality of contextualized depth maps 206, such as according to their temporal proximity to the current depth map being estimated. In some aspects, the one or more weights 208 may be determined using a weighting function that assigns higher weights to contextualized depth maps 206 that are closer in time to the current depth map, as they are likely to be more relevant and provide more accurate information.

Alternatively, or in addition, the one or more weights 208 may be based on an uncertainty or confidence associated with each contextualized depth map 116 of the plurality of contextualized depth maps 206. In certain aspects, the system 100 may generate uncertainty estimates along with the contextualized depth maps 206, indicating a confidence level of the depth predictions. In some aspects, the depth map aggregator 210 may assign higher weights to contextualized depth maps 206 with lower uncertainty or higher confidence, as they are likely to be more reliable.

In some aspects, the one or more weights 208 may be adaptively adjusted based on the scene complexity or motion dynamics. For example, in dynamic scenes with rapid changes, the depth map aggregator 210 may assign higher weights to a more recent contextualized depth map 116 to capture the current scene structure accurately. Conversely, in static or slowly changing scenes, the depth map aggregator 210 may distribute weights more evenly across the plurality of contextualized depth maps 206 to leverage temporal consistency.

In some aspects, one or more learning-based approaches may be used to obtain the one or more weights 208. For example, the weights can be learned from data using machine learning techniques. By training the system 200 on a large dataset of depth maps and corresponding ground truth depth information, weights can be learned that minimize the depth estimation error. Accordingly, a learning-based approach may allow the system to adapt to different scenarios and learn a weighting scheme based on the available data.

In some aspects, once the one or more weights 208 are determined, the depth map aggregator 210 may apply the one or more weights to the plurality of contextualized depth maps 206 and combines them to generate the contextually consistent depth map 212. In some aspects, the combination of the plurality of depth maps 206 may be performed using a weighted sum or other aggregation techniques that preserve the spatial and/or temporal dependencies among the depth maps.

In some aspects, the resulting contextually consistent depth map 212 incorporates information from multiple time steps, providing a more consistent and accurate representation of a scene depth. By considering the temporal context and adaptively weighting the contributions of previous depth maps, the system 200 may mitigate the effects of noise, occlusions, and other artifacts that may be present in individual depth maps.

In some aspects, the contextually consistent depth map 212 offers several benefits including, but not limited to improved accuracy, improved temporal consistency, improved robustness to challenging scenarios, and/or enhanced downstream applications. For example, by incorporating information from multiple depth maps and considering the temporal context, the contextually consistent depth map 212 may provide a more accurate representation of the scene depth compared to individual depth maps. Utilizing the depth map aggregator 210 may help to mitigate the effects of noise, occlusions, and other artifacts that may be present in individual depth maps. Moreover, in some aspects, the contextually consistent depth map 212 may provide temporal consistency across consecutive time steps. For example, by considering the depth estimates from previous frames and adaptively weighting them, the system 200 may generate depth maps that are coherent over time, reducing flickering or sudden changes in depth values, especially when used in downstream tasks.

In some aspects, the contextually consistent depth map 212 may perform better in challenging scenarios such as dynamic scenes, occlusions, or varying lighting conditions. That is, by leveraging the temporal context and adaptive weighting, the system 200 may handle these challenges more effectively compared to relying on a single depth map. In some aspects, the contextually consistent depth map 212 may be provided to one or more downstream applications, such as but not limited to autonomous navigation, 3D reconstruction, object detection and tracking, augmented reality applications, and BEV segmentation applications. In some aspects, the improved accuracy and temporal consistency of the contextually consistent depth map 212 may lead to better performance and reliability in such applications.

An example for generating a contextually consistent depth map 212 may be as follows. The depth maps 204 within the window 202 may be denoted as d₍ₜ₋ᵢ₎, where t represents the current time step and i ranges from 1 to n, indicating the relative temporal distance from a current time step. For example, d₍ₜ₋ᵢ₎ may represent a depth map from an immediately preceding time step, while d₍ₜ₋ₙ₎ may represent a depth map from n time steps ago.

In some aspects, to estimate a contextually consistent depth map at the current time step t, the system 200 may process each depth map 102 within the window 202 using the contextual depth map system 100 described in FIG. 1 to generate a corresponding predicted depth map d_{(t, i)} for each depth map in the window.

In some aspects, the predicted depth maps d_{(t, i)} may then be combined using a weighted average to obtain the final estimated depth map at time t. The weights assigned to each predicted depth map may be denoted as γᵢ, where i ranges from 1 to n. In some aspects, the weights determine the contribution of each predicted depth map to the final estimate.

In some aspects, the weights [symbol] can be determined based on various factors, such as the temporal proximity of the depth maps to the current time step, the confidence or uncertainty associated with each predicted depth map, or the scene dynamics. In some examples, the weights may be assigned using a function that gives higher weights to more recent depth maps and lower weights to older depth maps. This approach prioritizes the contribution of depth maps that are closer in time to the current depth map being estimated.

Mathematically, in some aspects, the estimated depth map at time t can be computed as:

$${\hat{d}}_{t} = {\sum }_{i = 0}^{n} {γ}_{i} {\hat{d}}_{t , i}$$

where \hat{d}ₜ represents an estimated depth map at time t, γᵢ represents a weight assigned to the predicted depth map \hat{d}_{t,i}, at time=i and n is the size of the window.

In some aspects, the size of the window n and the weights [symbol] may be treated as hyperparameters that can be tuned based on the specific requirements of the application or the characteristics of the scene. The values for these hyperparameters may be determined through empirical evaluation or learned from data using machine learning techniques.

### Aspects Related to Generating a Birds-Eye View

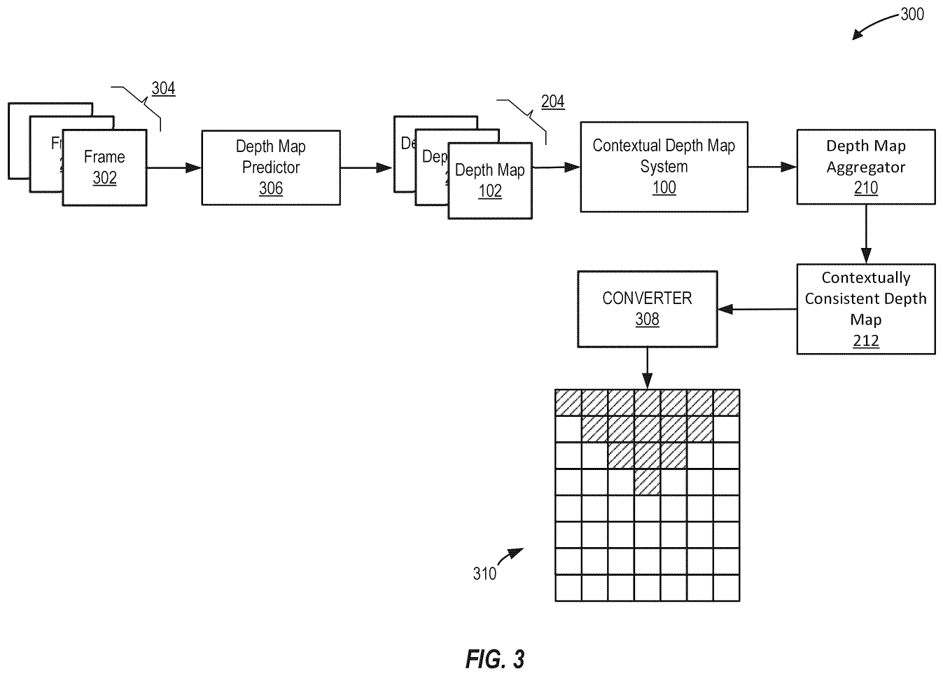

FIG. 3 depicts an example system 300 for generating a contextually consistent depth map 212 and a birds-eye view representation 310 of a scene, in accordance with aspects of the present disclosure. In some aspects, the system 300 includes one or more components to process frames 304, predict depth maps 102, apply contextual embeddings, and aggregate the depth maps to obtain the contextually consistent depth map 212. In some aspects, the contextually consistent depth map 212 may be used, along with corresponding input frames, to generate a birds-eye view representation 310 of a portion of a scene. In some aspects, the birds-eye view representation 310 is a top-down perspective of a scene, generated by transforming the contextually consistent depth map 212 and the corresponding input frames using techniques such as orthographic or perspective projection, to provide a comprehensive and accurate depiction of a scene's layout and object positions.

In some aspects, a frame 302 of the plurality of frames 304 may be received at a depth map predictor 306. In some aspects, the frame 302 refers to an individual frame from the plurality of frames 304, and is used to distinguish between a single frame (302) and the plurality of frames (304) for clarity. In some aspects, the frame 302 may be obtained from one of various sources. For example, in some aspects, the frame 302 may be obtained from an image sensor, such as a camera, which may capture a two-dimensional representation of a scene from a particular viewpoint. The image sensor may be a monocular camera, a stereo camera setup, or any other suitable imaging device. While a stereo camera setup can provide depth information through the disparity between the left and right camera views, aspects discussed herein can enhance the depth estimation process by incorporating temporal context and addressing challenges such as occlusions, textureless regions, or inconsistencies between the stereo views.

In other aspects, the frame 302 may be acquired from a LIDAR (Light Detection and Ranging) sensor. LIDAR sensors may emit laser pulses and measure the time it takes for the pulses to reflect back from objects in the scene, providing depth information. While LIDAR can directly provide depth information, the aspects discussed herein can enhance the depth estimation process by incorporating temporal context and addressing challenges such as sparse or irregular point clouds, limited resolution, or noise in the LIDAR data. The LIDAR data may be processed and converted into a frame-like representation to be used as input to the system 300. In some aspects, the frame 302 may be obtained through a fusion of multiple sensors, such as a combination of camera and LIDAR data. In some aspects, sensor fusion techniques may be employed to align and integrate data from different sensors, to create a more comprehensive representation of a scene in the form of the frame 302.

In some aspects, the plurality of frames 304 may refer to a sequence or collection of frames captured over time. In some aspects, the plurality of frames 304 may be obtained from a video stream, where each frame corresponds to a different time instance. In some examples, the frames in the plurality of frames 304 may be consecutive frames or a subset of frames selected at regular intervals. The plurality of frames 304 may capture the temporal evolution of the scene, providing information about the movement of objects, changes in the environment, and the overall dynamics of the scene.

In certain aspects, the plurality of frames 304 may be processed sequentially, where each frame is analyzed individually, such as in the order of capture. Alternatively, the plurality of frames may be processed in parallel, allowing for efficient computation and utilization of system resources.

In some aspects, the frame 302 may be input into a depth map predictor 306, which may be a machine learning model configured to estimate depth information from input frames. In some aspects, the depth map predictor may analyze the visual content of a frame 302 and generate a corresponding depth map that represents the distance or depth of objects in the scene, such as relative to a viewpoint (e.g., of a sensor). In some aspects, the depth map predictor 306 may employ one or more of various techniques and/or architectures to perform depth estimation. In some aspects, the depth map predictor 306 may be implemented as a convolutional neural network (CNN) trained on a large dataset of images with corresponding ground truth depth maps; the CNN may learn to extract relevant features from the input frame and map them to depth values.

In some aspects, the depth map predictor 306 may utilize monocular depth estimation techniques, where a single input frame may be used to infer depth information. As previously discussed, monocular depth estimation may rely on cues such as object sizes, textures, occlusions, and perspective geometry to estimate depth from a single image. In some aspects, the depth map predictor 306 may utilize stereo depth estimation techniques if the input frames are captured from a stereo camera setup. In some aspects, stereo depth estimation may compare differences between left and right camera views to triangulate depth based on a disparity between corresponding points in the two views. In some aspects, the depth map predictor 306 may incorporate additional information, such as camera calibration parameters, sensor characteristics, or prior knowledge about the scene, to improve the accuracy and reliability of depth estimation.

In some aspects, the output of the depth map predictor 306 is a depth map 102, which may be a two-dimensional representation of the estimated depth values for each pixel in the frame 302. In some aspects, the depth map 102 may be represented as a grayscale image, where darker pixels indicate closer objects and lighter pixels indicate farther objects, or vice versa, depending on the chosen representation. In some aspects, the depth map predictor 306 may process each frame 302 in the plurality of frames 304, to generate a corresponding depth map 102; these depth maps may be collectively referred to as depth maps 204, where each depth map corresponds to a specific frame 302 in the plurality of frames 304. In some aspects, the depth maps 204 capture the depth information for different time instances of the scene.

In some aspects, and as previously described with respect to FIG. 1 and FIG. 2, the depth maps 204 are then input into the contextual depth map system 100, which may apply contextual embeddings to the depth maps to obtain contextualized depth maps (e.g., contextualized depth maps 206 of FIG. 2). In some aspects, the contextualized depth maps generated by the contextual depth map system 100 may be passed to the depth map aggregator 210. As previously described with respect to FIG. 2, the depth map aggregator 210 may combine the contextualized depth maps to obtain a contextually consistent depth map 212.

In some aspects, the contextually consistent depth map 212 may be input, along with corresponding input frames (e.g., frames 304), into a converter 308. In some aspects, the converter 308 may be a module or a machine learning model configured to transform the contextually consistent depth map 212 and the corresponding input frames from a camera's perspective to a birds-eye view perspective. The birds-eye view, also known referred to as a top-down view, may provide a representation of the scene as if viewed from directly above, looking downwards.

In some aspects, the converter 308 may project the surfaces (e.g., of objects) captured in the input frames and contextually consistent depth maps onto a two-dimensional plane that represents the birds-eye view. In some aspects, this transformation provides a more intuitive understanding of the spatial layout and relationships between objects in a scene. In some aspects, to perform the birds-eye view transformation, the converter 308 may employ one or more various techniques, depending on the available input data and the desired level of accuracy. In some aspects, the converter 308 may apply a perspective transformation technique which may utilize a camera's intrinsic and/or extrinsic parameters to perform a perspective transformation on the input frames and depth map. In some aspects, the intrinsic parameters describe the internal characteristics of the camera, such as focal length and principal point, while the extrinsic parameters specify the camera's position and orientation relative to the scene. By applying a perspective transformation, the converter 308 may map the pixels from the camera's view to the corresponding locations in the birds-eye view representation 310. In some aspects, this transformation takes into account the depth information from the contextually consistent depth map 212 to accurately position the objects in the birds-eye view representation.

In some aspects, the converter 308 may apply a depth-based scaling technique, where the depth values from the contextually consistent depth map 212 may be used to scale and position objects in the birds-eye view representation 310. For example, in some aspects, the converter 308 may divide the scene into a grid or a set of cells, and for each cell, it may determine an average depth value based on the contextually consistent depth map 212. In some aspects, the size of each cell in the birds-eye view representation 310 may be scaled proportionally to its depth, such that closer objects appear larger and farther objects appear smaller. By applying depth-based scaling, the converter 308 may create a birds-eye view representation 310 representation that preserves the relative sizes and positions of objects in the scene based on their depth information.

In some aspects, the converter 308 may utilize a 3D point cloud projection technique, using depth data derived from the contextually consistent depth map 212, to transform and project a 3D point cloud onto a 2D plane to generate the birds-eye view representation 310. In some aspects, each point in the point cloud may be mapped to its corresponding location in the birds-eye view representation 310 based on its 3D coordinates. In some aspects, the converter 308 may utilize techniques such as orthographic projection or perspective projection to perform this transformation. The resulting birds-eye view representation 310 may provide a detailed and accurate depiction of the scene's layout and object positions.

In some aspects, the converter 308 may be trained using a large dataset of input frames, depth maps, and corresponding ground truth birds-eye view representations. By learning from this data, the converter 308 can improve its ability to generate accurate and detailed birds-eye view representation 310 across different scenes and environments.

The birds-eye view representation 310 generated by the converter 308 may have numerous applications in various domains. For example, the birds-eye view representation 310 can be used for tasks such as obstacle detection, path planning, and/or navigation in autonomous vehicles or robotics. The birds-eye view representation 310 may provide a more intuitive and easily interpretable representation of the scene, enabling decision-making and planning algorithms to operate more effectively. Furthermore, the birds-eye view representation 310 may be utilized for scene understanding and analysis tasks, as it may allow for easier identification and localization of objects, estimation of distances and sizes, and/or understanding of the overall scene structure.

### Aspects Related to Training a Contextualized Depth Estimation Model

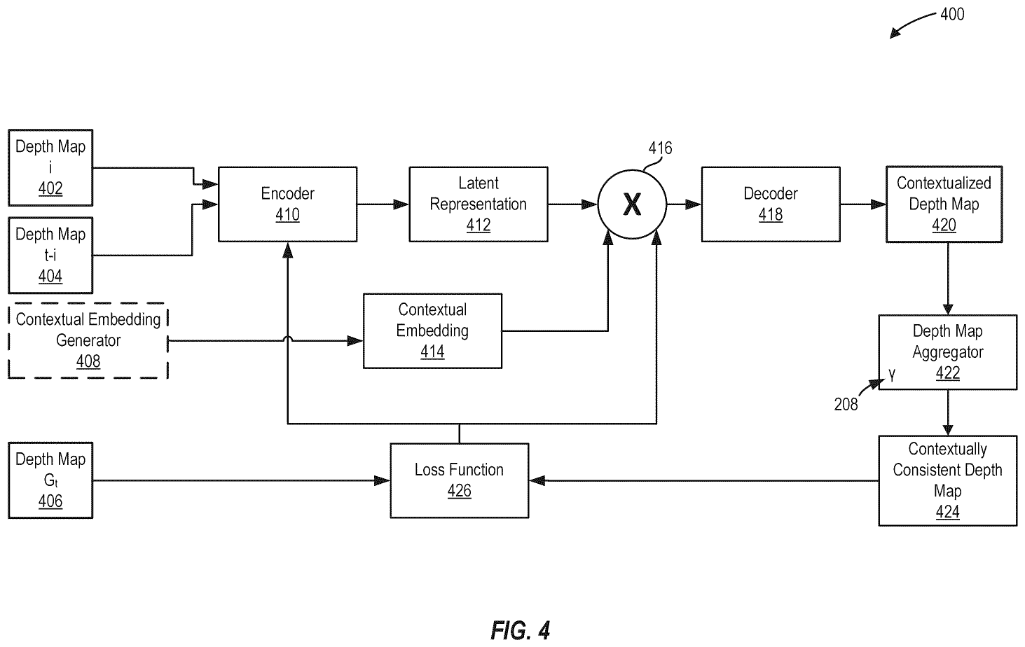

FIG. 4 illustrates a training system 400 for training a contextual depth map system 100 described in FIG. 1 in accordance with aspects of the present disclosure. In some aspects, the training system 400 may utilize training data, including depth maps 402 and 404, to learn various parameters of the system components, such as the encoder 410, contextual embedding generator 408, and decoder 418. The encoder 410, contextual embedding generator 408, and decoder 418 in the training system 400 correspond to the encoder 104 (FIG. 1), contextual embedding generator 110 (FIG. 1), and decoder 114 (FIG. 1) in the contextual depth map system 100 (FIG. 1), respectively. The training process involves minimizing the difference between the estimated contextualized depth map and the ground truth depth map using a loss function, which will be discussed in more detail later in the description of FIG. 4.

In some aspects, the training data used for the training system 400 may include a depth map 402 corresponding to the current frame i, which may represent a first frame of a window of frames used for training. The depth map 402 may serve as a target frame for which the encoder 410, contextual weighting mechanism 416, decoder 418, and depth map aggregator 422 aim to estimate the contextually consistent depth map 424. In some aspects, the training data may include depth map 404 corresponding to a previous frame t-i, where i represent may represent a temporal offset between the current frame at time=t and another frame in a window of frames. By providing depth information from both the current and one or more previous frames within a window, the encoder 410, contextual weighting mechanism 416, decoder 418, and depth map aggregator 422 can learn to leverage contextual content for improved depth estimation.

In some aspects, the encoder 410 may be an initially untrained version of the encoder 104 described in FIG. 1. In some aspects, during the training process, the encoder 410 learns to map the input depth maps 402 and 404 into latent representations 412. The contextual embedding generator 408, which may be similar to or the same as the contextual embedding generator 110 described with respect to FIG. 1, may generate one or more contextual embeddings 414, based on the depth maps 402 and 404, during a training process. The contextual weighting mechanism 416 may be similar to or the same as the contextual weighting mechanism 108 described in FIG. 1, but in an initially untrained state. In some aspects, the encoder 410, contextual embedding generator 408, and contextual weighting mechanism 416, may be trained together in the training system 400. In some aspects, and during training, the contextual weighting mechanism 416 may learn to combine the latent representations 412 and the contextual embeddings 414 using one or more weighting mechanisms, such as cross-attention.

In some aspects, the decoder 418 may be an initially untrained version of the decoder 114 described in FIG. 1. In some aspects, during training, the decoder 418 may learn to map the combined representation from the contextual weighting mechanism 416 back into a depth map space, generating a contextualized depth map 420. In some aspects, the depth map aggregator may aggregate a plurality of contextualized depth maps 420 into a contextually consistent depth map 424.

In some aspects, the loss function 426 may measure a discrepancy between the estimated contextually consistent depth map 424 and the ground truth depth map 406. The ground truth depth map 406 may be provided as a target or desired output for the contextually consistent depth map 424 during training. In some aspects, the loss function 426 may compute metrics such as mean squared error (MSE), mean absolute error (MAE), or other suitable loss functions that quantify differences between the predicted and ground truth depth maps. By minimizing this loss, the encoder 410 and/or the contextual weighting mechanism may learn to generate accurate and contextually consistent depth estimates based on the depth maps (e.g., 402 and/or 404) input into the encoder 410.

For example, the loss function 426 may be configured to capture various aspects of the depth map, such as pixel-wise depth values, structural similarity, and smoothness. In some aspects, MSE may generate an average squared difference between the estimated depth values and the ground truth depth values, and penalize large deviations from the ground truth while encouraging the encoder 410 and/or contextual weighting mechanism 416 to minimize an overall pixel-wise error. In some aspects, the MSE loss can be expressed as:

$${L}_{MSE} \frac{1}{N} \sum {( {d}_{est} - {d}_{gt} )}^{2} ,$$

where N represents the total number of pixels, dₑₛₜ represents the estimated depth values, and d_{gt} represents the ground truth depth values. In some aspects, MAE may generate the average absolute difference between the estimated depth values and the ground truth depth values, by measuring the pixel-wise accuracy of the depth estimates without penalizing large errors as heavily as MSE. In some aspects, the MAE loss can be expressed as:

$${L}_{MSA} \frac{1}{N} \sum ( {d}_{est} - {d}_{gt} ) .$$

Other loss functions may include, but are not limited to structural similarity index (SSIM), which may assess the structural similarity between the estimated depth map and the ground truth depth map by considering factors such as, but not limited to, luminance, contrast, and/or structure to quantify the perceived quality of the depth estimates, and smoothness loss, which may promote the generation of smooth and locally consistent depth estimates by penalizing large variations in depth values between neighboring pixels.

In some aspects, the choice of the loss function 426 may depend on the specific requirements and characteristics of the depth estimation task. In some aspects, a combination of multiple loss functions may be used to capture different aspects of the depth map and guide the model towards generating accurate and contextually consistent depth estimates.

In some aspects, the loss function 426 may be computed for each batch of training samples, and the gradients of the loss with respect to the model parameters may be generated using backpropagation. The gradients may then be used to update one or more parameters of the encoder 410 and/or the contextual weighting mechanism 416 in an iterative manner, by using optimization algorithms such as stochastic gradient descent (SGD) or adaptive methods like Adam and AdamOptimizer.

In some aspects, and during the training process, the training system 400 may iteratively update one or more parameters of the encoder 410 and/or contextual weighting mechanism 416 based on gradients generated from the loss function 426. In some aspects, this process allows the encoder 410 and/or contextual weighting mechanism 416 to learn representations and mappings for contextually consistent depth estimation. In some aspects, once trained, the encoder 410 and/or contextual weighting mechanism 416 can then be deployed for inference, where the encoder 410 and/or contextual weighting mechanism 416 may take a depth map corresponding to a current frame and a depth map corresponding to a previous frame, and generate a contextualized depth map 420. In some aspects, once trained, the encoder 410 and/or contextual weighting mechanism 416 may take a depth map corresponding to a current frame and a depth map corresponding to a previous frame, generate a plurality of contextualized depth maps, and aggregate the plurality of contextualized depth maps into a contextually consistent depth map 424.

### Example Artificial Intelligence System for Generating Contextualized Depth Maps

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

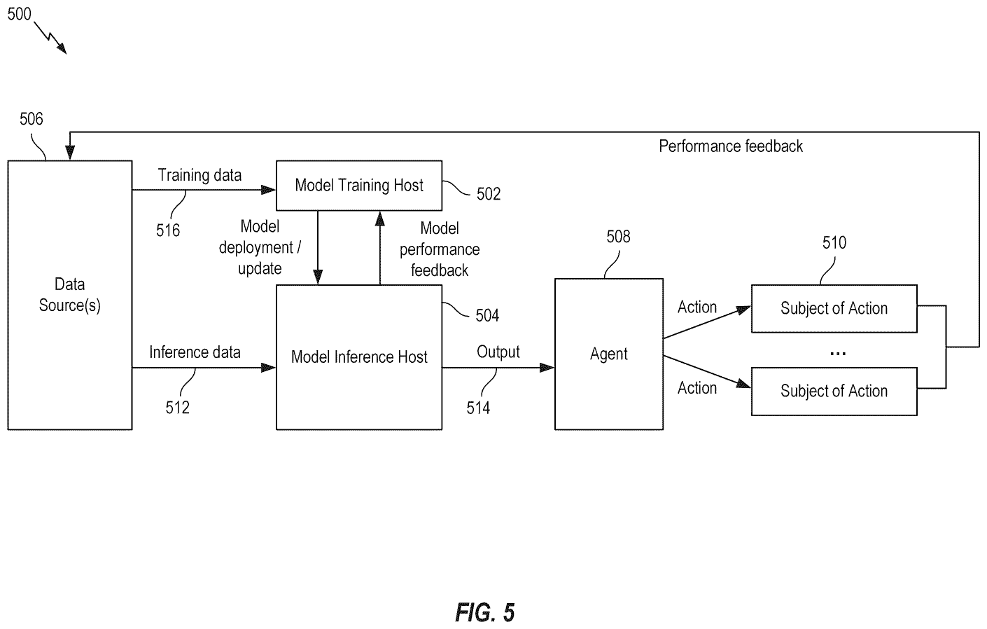

FIG. 5 is a diagram illustrating an example AI architecture 500 that may be used to implement the machine learning models and techniques for generating contextualized depth maps in accordance with aspects of the present disclosure. As illustrated, the architecture 500 includes multiple logical entities, such as a model training host 502 for training the machine learning model with latent modulation and adaptive weighting, a model inference host 504 for running inference using the trained model, data source(s) 506 providing training and inference data, and an agent 508 that utilizes the model's output. This AI architecture could be used to enable the example disclosed techniques for generating contextualized depth maps in various machine learning applications.

The model inference host 504, in the architecture 500, is configured to run an ML model based on inference data 512 provided by data source(s) 506. The model inference host 504 may produce an output 514 (e.g., a contextualized depth map) based on the inference data 512, that is then provided as input to the agent 508.

The agent 508 may be an element or entity that utilizes the output of the machine learning model hosted by the model inference host 504. The agent 508 could be a software component, a hardware accelerator, or a system that leverages the contextualized depth maps produced by the model for various downstream tasks such as autonomous driving, augmented reality, or robotic navigation.

For example, if the output 514 from the model inference host 504 is a contextualized depth map obtained through latent modulation and adaptive weighting, the agent 508 may be an autonomous driving system that uses the depth information for obstacle detection and path planning. As another example, if the output 514 is a contextually consistent depth map produced by a model trained with a temporal context, the agent 508 could be an augmented reality application that uses the depth information for realistic rendering of virtual objects.

After receiving the output 514 from the model inference host 504, the agent 508 may determine how to utilize it. For instance, if the agent 508 is an autonomous driving system and the output is a contextually consistent depth map, it may use the depth information to detect obstacles, estimate their distances, and plan a safe trajectory. If the agent 508 decides to use the output 514, it may apply it to the subject of the action 510, which represents the data being processed or enhanced. In the autonomous driving example, the subject of action 510 would be the vehicle's control system. In some cases, the agent 508 and subject of action 510 may be tightly integrated.

The data sources 506 may be configured to collect data used as training data 516 for the model training host 502 to train the machine learning models for generating contextualized depth maps. The data sources 506 may also provide inference data 512 to the model inference host 504. This data could come from various entities and may include the subject of action 510. For example, for training a depth estimation model, the data sources 506 may collect video frames and corresponding ground truth depth maps. The model training host 502 can then monitor the model's performance on this data to determine if retraining or fine-tuning with the latent modulation and adaptive weighting techniques is necessary to improve accuracy. In some cases, the agent 508 and the subject of action 510 are the same entity.

The data sources 506 may be configured for collecting data that is used as training data 516 for training the machine learning model with latent modulation and adaptive weighting. The data sources 506 may also provide inference data 512 (also referred to as input data) for feeding the trained model during inference. In particular, the data sources 506 may collect data relevant to the depth estimation task at hand, such as video frames from cameras or sensors. This data may come from one or more of various sources, including the subject of action 510, which represents the data being processed by the model. The collected data is provided to the model training host 502 for training and fine-tuning the model for generating contextualized depth maps. For example, after the subject of action 510 (e.g., a video frame) is processed by the model, the output 514 (e.g., a predicted contextualized depth map and/or a contextually consistent depth map) may be compared to ground truth annotations to evaluate the model's performance. If the output 514 is not sufficiently accurate, this performance feedback may be used by the model training host 502 to further train the model using the disclosed latent modulation and adaptive weighting techniques, aiming to improve its depth estimation accuracy. The updated model may then be deployed to the model inference host 504.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, machine learning models utilizing latent modulation and/or adaptive weighting are deployed at or on a computing device for enhancing the performance of depth estimation tasks. More specifically, a model inference host, such as model inference host 504 in FIG. 5, may be deployed at or on the computing device for running the model to generate contextualized depth maps, generate contextually consistent depth maps, and improve depth estimation accuracy.

In some other aspects, the machine learning model for generating contextualized depth maps is deployed at or on an embedded system or mobile device for enabling efficient on-device inference. More specifically, a model inference host, such as model inference host 504 in FIG. 5, may be deployed at or on the embedded system or mobile device for running the model to obtain high-quality depth estimates while meeting resource constraints.

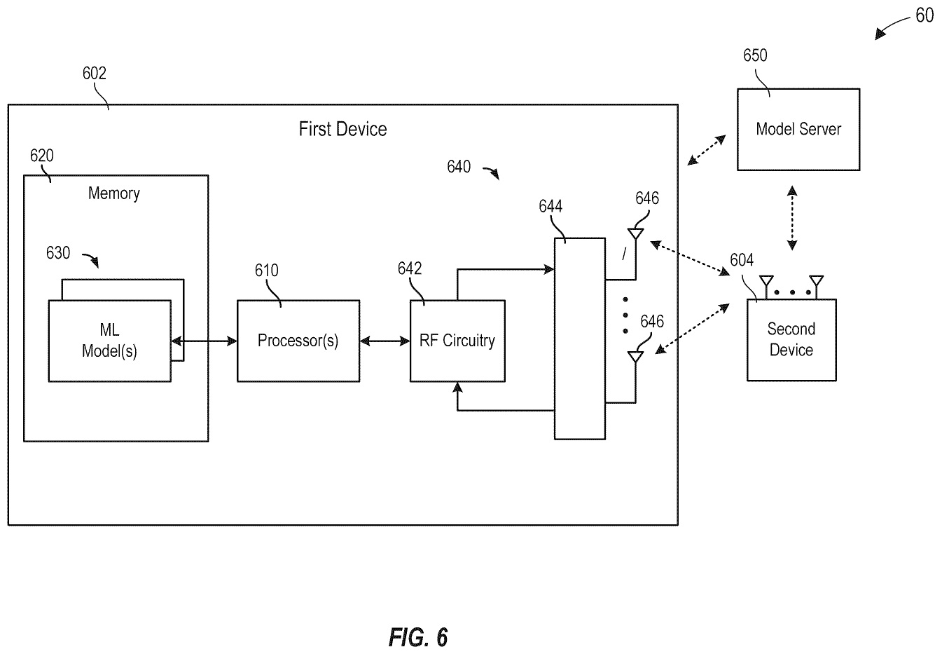

FIG. 6 illustrates an example AI architecture 600 of a first computing device 602 that is in communication with a second computing device 604. The first computing device 602 may be a server or cloud computing platform as described herein with respect to FIG. 5. Similarly, the second computing device 604 may be an embedded system or mobile device as described herein with respect to FIG. 5. Note that the AI architecture of the first computing device 602 may be applied to the second computing device 604.

The first computing device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a model inference mode, the processor 610 may transform input data (e.g., video frames, sensor readings) into a format suitable for the model that generates contextualized depth maps. The processor 610 may then run the model on the formatted input data to generate a contextualized depth map. The processor 610 may be coupled to a transceiver 640 for transmitting the contextualized depth map to and/or receiving input data from one or more connected devices 646. The transceiver 640 includes interface circuitry 642 and 644 for converting between the digital signals of the processor and any transmission protocol used by the connected devices 646. The connected devices 646 may be cameras, sensors, displays, or storage that provide input to or consume the output from the model.

When receiving input data via the connected devices 646 (e.g., from the second computing device 604), the transceiver interface circuitry 642 and 644 may convert the received signals to a baseband frequency and then to digital signals for processing by the processor 610. The processor 610 may format the digital input signals and feed them into the model for generating contextualized depth maps.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may take a sequence of video frames as input to predict a contextualized depth map using one or more example techniques previously described, such as latent modulation and adaptive weighting. The input data may include, for example, frames from a camera, or depth maps obtained from a depth sensor. The output data may include, for example, a contextualized depth map that is temporally consistent and captures the scene dynamics, which is obtained by applying latent modulation and adaptive weighting within the model. In certain aspects, the output depth map may be considered a “virtual” result in that it is not directly measured but rather inferred by the model based on the input observations and the learned temporal context. In other cases, the output depth map may correspond to a physical quantity that is measurable in principle but not directly observed by the sensors available to the system. Note that other input data and/or output data may be used in addition to or instead of the examples described herein, depending on the specific depth estimation task and the available sensors.

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 that utilizes latent modulation and/or adaptive weighting to trigger one or more lifecycle management (LCM) tasks. For example, the model server 650 may determine whether to activate or deactivate the use of a particular model for generating contextualized depth maps at the first computing device 602 and/or the second computing device 604, based on factors such as the accuracy requirements, computational budget, and energy constraints of each device. The model server 650 may then provide instructions to the respective devices to manage their model usage accordingly. In some cases, the model server 650 may determine whether to switch to a different variant of the ML model 630 at the first computing device 602 and/or the second computing device 604, based on changes in the operating conditions or performance objectives. For instance, the model server may instruct a device to switch from a complex model with high accuracy to a simpler model with lower latency when the battery level falls below a threshold. In yet further examples, the model server 650 may act as a central coordinator for collaborative learning of models for generating contextualized depth maps across multiple devices, using techniques such as federated learning to train a global model from locally-computed updates while preserving data privacy.

### Example Artificial Intelligence Model for Generating Contextualized Depth Maps

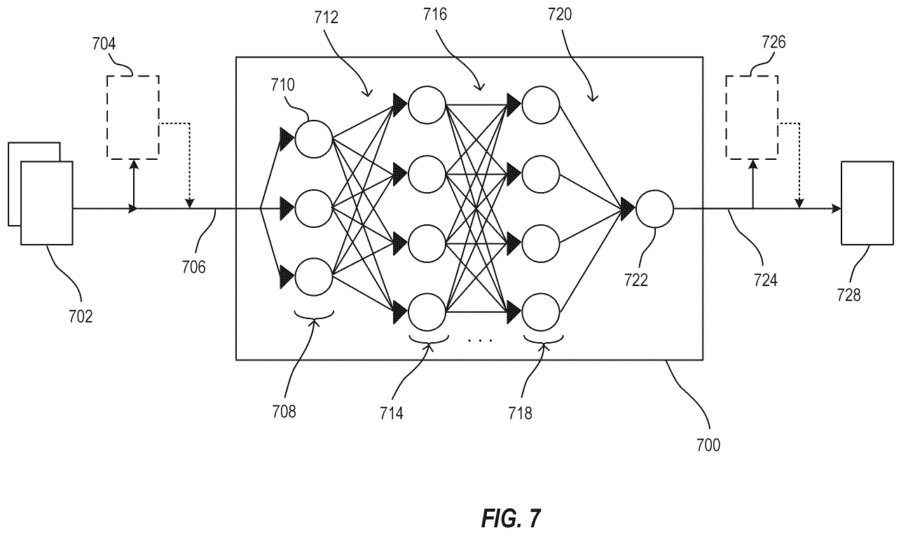

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 512 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression. For example, in the context of generating contextualized depth maps, an autoencoder can be used to encode depth maps into a compact latent representation, which can then be modulated and decoded to obtain the final contextualized depth map.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models. For instance, a GAN could be used to generate realistic depth maps for training a model that generates contextualized depth maps.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing. In the context of generating contextualized depth maps, a transformer could be used to model the temporal dependencies between consecutive depth maps and generate a contextualized depth map that is consistent with the scene dynamics.

Another example type of ANN structure, is a model with one or more invertible layers. Models of this type may be inverted or “unwrapped” to reveal the input data that was used to generate the output of a layer. For example, an invertible model could be used to map a contextualized depth map back to the corresponding input depth map, enabling the analysis of how the model incorporates temporal context.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training for Generating Contextualized Depth Maps

There are a variety of model training techniques and processes that may be used prior to, or at some point following, deployment of an ML model, such as ANN 700 of FIG. 7.

As part of the development process for machine learning models that generate contextualized depth maps using latent modulation and adaptive weighting, relevant training data must be gathered or generated. For example, training data may include ground truth depth maps, as well as corresponding video frames or image sequences. This data can be used to train the model to accurately incorporate temporal context and generate consistent depth estimates for the given scene. In certain instances, the training data may originate from depth sensors on user devices (e.g., smartphones, robots, vehicles), dedicated data collection equipment (e.g., multi-camera rigs, LiDAR scanners), or public datasets. In some cases, the training data may be aggregated from multiple sources to cover a wide range of scenarios and improve model generalization. For example, crowdsourcing platforms or online databases may be leveraged to gather diverse examples of video sequences and depth maps for training models that generate contextualized depth maps. In another example, training data may be generated synthetically using 3D rendering engines or generative models to augment real-world samples. The training data collection process can be performed offline, resulting in a static dataset for batch training, or online, where new samples are continuously incorporated into the model training pipeline. For example, an autonomous vehicle may periodically upload new training samples gathered during operation to a server, which then fine-tunes the model for generating contextualized depth maps using online learning techniques. For offline training, data collection and model updates can occur at a central location (e.g., a datacenter) or be distributed across multiple nodes (e.g., a fleet of vehicles). For online training, the model may be adapted locally on each device or by a remote server that receives streaming data from the devices.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information. For example, in the context of training models for generating contextualized depth maps, data augmentation techniques such as random cropping, flipping, or scaling can be applied to the input video frames and depth maps to increase the diversity of the training data and improve the model's robustness.

A transfer learning technique may be used which involves using a pre-trained model as a starting point for training a new model, which may be useful when training data is limited or when there are multiple tasks that are related to each other. For instance, a model pre-trained on a large dataset of indoor scenes could be fine-tuned on a smaller dataset of outdoor scenes to generate contextualized depth maps for autonomous driving applications.

A multi-task learning technique may be used which involves training a model to perform multiple tasks simultaneously to potentially improve the performance of the model on one or more of the tasks. For example, a model could be trained to jointly predict depth maps and semantic segmentation masks from video frames, leveraging the shared representation to improve the accuracy of both tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model.

Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique. Decentralized, distributed, or shared learning, such as federated learning, may enable training of machine learning models that generate contextualized depth maps using latent modulation and adaptive weighting on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of depth estimation tasks, for example, federated learning may be used to improve model performance by allowing it to learn from a wide range of environments and conditions. For instance, a model for generating contextualized depth maps may be trained on data collected from a large number of smartphones or autonomous vehicles, each with its own camera configuration and operating domain, to improve its robustness and generalization. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the model for generating contextualized depth maps achieves satisfactory performance across all participating devices. By enabling collaborative learning while keeping data localized, federated learning allows the development of powerful models that can leverage diverse datasets without compromising privacy or security.

In some implementations, one or more devices or services may support processes relating to the usage, maintenance, activation, and reporting of machine learning models that generate contextualized depth maps using latent modulation and adaptive weighting. In certain instances, all or part of the training data or the trained model may be shared across multiple devices to provide or improve the depth estimation capabilities. For example, a smartphone with a depth sensor may share its data with a smartphone having only a single camera, enabling the latter to train a depth estimation model that incorporates temporal context. In some cases, signaling mechanisms may be employed to communicate the capabilities and requirements for performing specific functions related to models that generate contextualized depth maps, such as the supported input and output formats, the available computational resources, or the ability to collect and share training data. These models may be used to support various applications, such as augmented reality, robotics, autonomous driving, or video processing, where accurate and efficient estimation of depth is crucial. The deployment of models for generating contextualized depth maps may occur at different levels of a system architecture, such as on individual devices (e.g., smartphones, vehicles), edge servers (e.g., base stations, access points), or cloud platforms, depending on factors such as latency requirements, data privacy concerns, and resource availability. By leveraging the disclosed techniques for incorporating temporal context, these models can provide high-quality depth estimates while operating under the constraints of each deployment scenario.

### Example Operations for Generating a Contextualized Depth Map

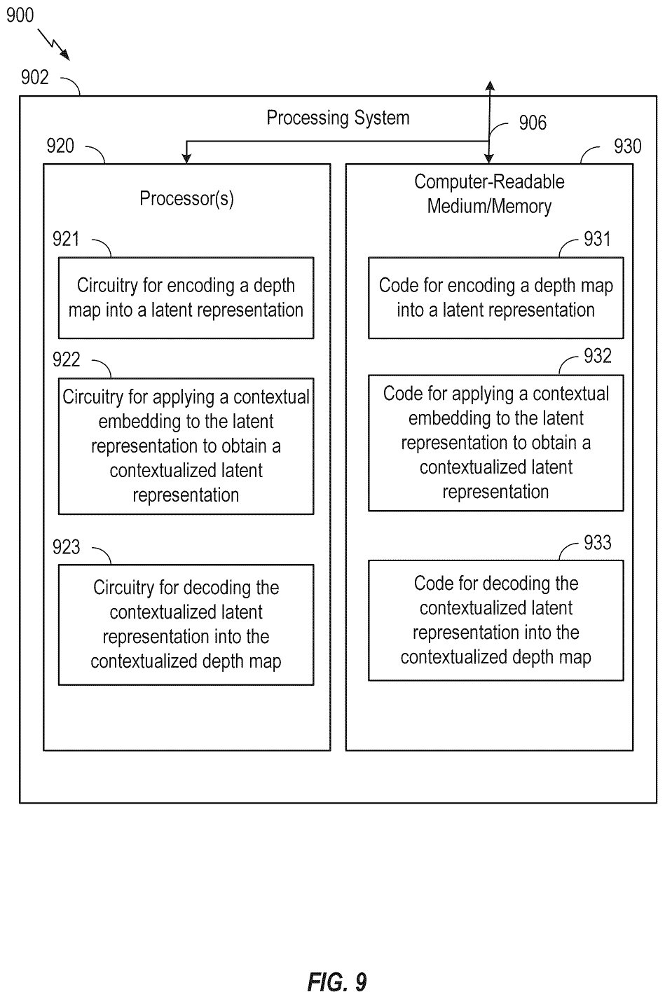

In certain aspects, method 800, or any aspect related to it, may be performed by an apparatus, such as processing system 900 of FIG. 9, which includes various components operable, configured, or adapted to perform the method 800. In certain aspects, method 800, or any aspect related to it, may be performed by the contextual depth map system 100 of FIG. 1, the system 200 for generating a contextually consistent depth map of FIG. 2, the system 300 for generating a birds-eye view representation of FIG. 3, and/or the training system 400 of FIG. 4.

Method 800 beings at block 802 with encoding a depth map into a latent representation.

Method 800 then proceeds to block 804 with applying a contextual embedding to the latent representation to obtain a contextualized latent representation.

Method 800 then proceeds to block 806 with decoding the contextualized latent representation into the contextualized depth map.

In certain aspects, method 800 further includes: encoding a second depth map into a second latent representation; applying a second contextual embedding to the second latent representation to obtain a second contextualized latent representation; decoding the second contextualized latent representation into a second contextualized depth map; and generating a contextually consistent depth map based on a weighted sum of the contextualized depth map and the second contextualized depth map frames adjacent in time in the sequence of frames are separated by a same time interval.

In certain aspects, method 800 further includes: generating a weighting corresponding to the contextualized depth map based on a temporal context associated with the contextualized depth map; and applying the weighting to the contextualized depth map.

In certain aspects, method 800 further includes: generating a weighting corresponding to the contextualized depth map based on a spatial context associated with the contextualized depth map; and applying the weighting to the contextualized depth map.

In certain aspects, method 800 further includes: inputting the contextually consistent depth map and a corresponding input frame into a first machine learning model trained to generate a birds-eye-view representations of scenes; and obtaining as output from the first machine learning model, based on the contextually consistent depth map, a birds-eye-view representation of a portion of a scene corresponding to the input frame.

In certain aspects, encoding the depth map comprises: inputting the depth map into a first machine learning model trained to encode depth maps into latent representations; and obtaining as output from the first machine learning model, based on the depth map, the latent representation.

In certain aspects, the first machine learning model includes a variational autoencoder.

In certain aspects, applying the contextual embedding to the latent representation comprises: generating the contextual embedding from metadata associated with a first frame and a second frame, wherein the second frame is subsequent in time to the first frame, and the depth map corresponds to the second frame; and cross-attending the contextual embedding with the latent representation.

In certain aspects, the contextual embedding is based on a temporal difference between the first frame and the second frame.

In certain aspects, the contextual embedding is based on a spatial difference between the first frame and the second frame.

In certain aspects, method 800 further comprises: inputting a frame into a first machine learning model trained to generate depth maps; and obtaining as output from the first machine learning model, the depth map.

In certain aspects, method 800 further comprises: obtaining the frame using at least one of an image sensor or a LIDAR sensor.

In certain aspects, method 800 further comprises: inputting a sequence of frames into a first machine learning model trained to generate depth maps; and obtaining as output from the first machine learning model, based on the sequence of frames, the depth map.

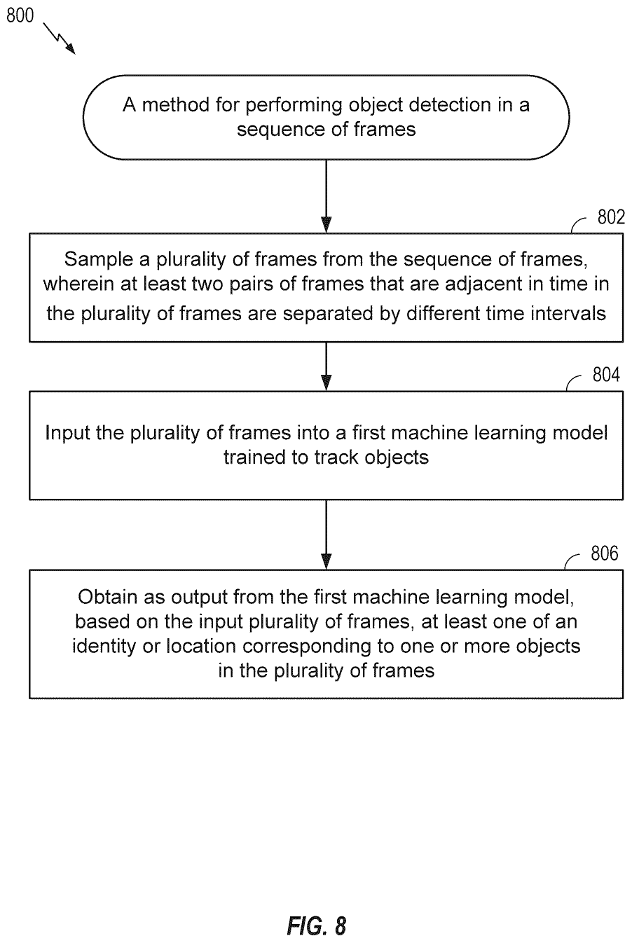

Note that FIG. 8 is just one example of a method, and other methods including fewer, additional, or alternative steps are possible consistent with this disclosure.

### Example Processing System for Generating a Contextualized Depth Map

FIG. 9 depicts aspects of an example processing system 900. The processing system 900 may be used to implement the contextual depth map system 100 of FIG. 1, the system 200 for generating a contextually consistent depth map of FIG. 2, the system 300 for generating a birds-eye view representation of FIG. 3, and/or the training system 400 of FIG. 4. The components of these systems, such as the encoder 104, contextual embedding generator 110, decoder 114, depth map predictor 306, converter 308, and their corresponding elements in the training system 400, may be realized using the processors, memory, and other hardware components of the processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 800 described with respect to FIG. 8, or any aspect related to it, including any additional steps or sub-steps described in relation to FIG. 8.

In the depicted example, computer-readable medium/memory 930 stores code (e.g., executable instructions) for encoding a depth map into a latent representation 931, code for applying a contextual embedding to the latent representation to obtain a contextualized latent representation 932, and code for decoding the contextualized latent representation into the contextualized depth map 933. Processing of the code 931-933 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry for encoding a depth map into a latent representation 921, circuitry for applying a contextual embedding to the latent representation to obtain a contextualized latent representation 922, and circuitry for decoding the contextualized latent representation into the contextualized depth map 923. Processing with circuitry 921-923 may enable and cause the processing system 900 to perform the method 800 described with respect to FIG. 8, or any aspect related to it.

### Example Clauses

Implementation examples are described in the following numbered clauses:

Clause 1: A method for generating a contextualized depth map, comprising: encoding a depth map into a latent representation; applying a contextual embedding to the latent representation to obtain a contextualized latent representation; and decoding the contextualized latent representation into the contextualized depth map.

Clause 2: The method of Clause 1, further comprising: encoding a second depth map into a second latent representation; applying a second contextual embedding to the second latent representation to obtain a second contextualized latent representation; decoding the second contextualized latent representation into a second contextualized depth map; and generating a contextually consistent depth map based on a weighted sum of the contextualized depth map and the second contextualized depth map.

Clause 3: The method of Clause 2, further comprising: generating a weighting corresponding to the contextualized depth map based on a temporal context associated with the contextualized depth map; and applying the weighting to the contextualized depth map.

Clause 4: The method of any one of Clauses 2-3, further comprising: generating a weighting corresponding to the contextualized depth map based on a spatial context associated with the contextualized depth map; and applying the weighting to the contextualized depth map.

Clause 5: The method of any one of Clauses 2-4, further comprising: inputting the contextually consistent depth map and a corresponding input frame into a first machine learning model trained to generate a birds-eye-view representations of scenes; and obtaining as output from the first machine learning model, based on the contextually consistent depth map, a birds-eye-view representation of a portion of a scene corresponding to the input frame.

Clause 6: The method of any one of Clauses 1-5, wherein encoding the depth map comprises: inputting the depth map into a first machine learning model trained to encode depth maps into latent representations; and obtaining as output from the first machine learning model, based on the depth map, the latent representation.

Clause 7: The method of Clause 6, wherein the first machine learning model includes a variational autoencoder.

Clause 8: The method of any one of Clauses 1-7, wherein applying the contextual embedding to the latent representation comprises: generating the contextual embedding from metadata associated with a first frame and a second frame, wherein the second frame is subsequent in time to the first frame, and the depth map corresponds to the second frame; and cross-attending the contextual embedding with the latent representation.

Clause 9: The method of Clause 8, wherein the contextual embedding is based on a temporal difference between the first frame and the second frame.

Clause 10: The method of any one of Clauses 8-9, wherein the contextual embedding is based on a spatial difference between the first frame and the second frame.

Clause 11: The method of any one of Clauses 1-10, further comprising: inputting a frame into a first machine learning model trained to generate depth maps; and obtaining as output from the first machine learning model, the depth map.

Clause 12: The method of Clause 11, further comprising: obtaining the frame using at least one of an image sensor or a LIDAR sensor.

Clause 13: The method of Clause 12, further comprising: inputting a sequence of frames into a first machine learning model trained to generate depth maps; and obtaining as output from the first machine learning model, based on the sequence of frames, the depth map.

Clause 14: One or more apparatuses, comprising: one or more memories comprising executable instructions; and one or more processors configured to execute the executable instructions and cause the one or more apparatuses to perform a method in accordance with any one of clauses 1-13.

Clause 15: One or more apparatuses, comprising: one or more memories; and one or more processors, coupled to the one or more memories, configured to cause the one or more apparatuses to perform a method in accordance with any one of Clauses 1-13.

Clause 16: One or more apparatuses, comprising: one or more memories; and one or more processors, coupled to the one or more memories, configured to perform a method in accordance with any one of Clauses 1-13.

Clause 17: One or more apparatuses, comprising means for performing a method in accordance with any one of Clauses 1-13.

Clause 18: One or more non-transitory computer-readable media comprising executable instructions that, when executed by one or more processors of one or more apparatuses, cause the one or more apparatuses to perform a method in accordance with any one of Clauses 1-13.

Clause 19: One or more computer program products embodied on one or more computer-readable storage media comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured to generate a contextualized depth map, comprising:
one or more memories configured to store a depth map; and
one or more processors, coupled to the one or more memories, configured to:
encode the depth map into a latent representation;
apply a contextual embedding to the latent representation to obtain a contextualized latent representation; and
decode the contextualized latent representation into the contextualized depth map.

2. The apparatus of claim 1, wherein the one or more processors are further configured to:
encode a second depth map into a second latent representation;
apply a second contextual embedding to the second latent representation to obtain a second contextualized latent representation;
decode the second contextualized latent representation into a second contextualized depth map; and
generate a contextually consistent depth map based on a weighted sum of the contextualized depth map and the second contextualized depth map.

3. The apparatus of claim 2, wherein to generate the contextually consistent depth map comprises to:
generate a weighting corresponding to the contextualized depth map based on a temporal context associated with the contextualized depth map; and
apply the weighting to the contextualized depth map.

4. The apparatus of claim 2, wherein to generate the contextually consistent depth map comprises to:
generate a weighting corresponding to the contextualized depth map based on a spatial context associated with the contextualized depth map; and
apply the weighting to the contextualized depth map.

5. The apparatus of claim 2, wherein the one or more processors are further configured to:
input the contextually consistent depth map and a corresponding input frame into a first machine learning model trained to generate a birds-eye-view representations of scenes; and
obtain as output from the first machine learning model, based on the contextually consistent depth map, a birds-eye-view representation of a portion of a scene corresponding to the input frame.

6. The apparatus of claim 1, wherein to encode the depth map comprises to:
input the depth map into a first machine learning model trained to encode depth maps into latent representations; and
obtain as output from the first machine learning model, based on the depth map, the latent representation.

7. The apparatus of claim 6, wherein the first machine learning model includes a variational autoencoder.

8. The apparatus of claim 1, wherein to apply the contextual embedding to the latent representation comprises to:
generate the contextual embedding from metadata associated with a first frame and a second frame, wherein the second frame is subsequent in time to the first frame, and the depth map corresponds to the second frame; and
cross-attend the contextual embedding with the latent representation.

9. The apparatus of claim 8, wherein the contextual embedding is based on a temporal difference between the first frame and the second frame.

10. The apparatus of claim 8, wherein the contextual embedding is based on a spatial difference between the first frame and the second frame.

11. The apparatus of claim 1, wherein the one or more processors are further configured to:
input a frame into a first machine learning model trained to generate depth maps;
obtain as output from the first machine learning model, the depth map.

12. The apparatus of claim 11, further comprising at least one of an image sensor or a LIDAR sensor configured to obtain the frame.

13. The apparatus of claim 1, wherein the one or more processors are further configured to:
input a sequence of frames into a first machine learning model trained to generate depth maps;
obtain as output from the first machine learning model, based on the sequence of frames, the depth map.

14. A method for generating a contextualized depth map, comprising:
encoding a depth map into a latent representation;
applying a contextual embedding to the latent representation to obtain a contextualized latent representation; and
decoding the contextualized latent representation into the contextualized depth map.

15. The method of claim 14, further comprising:
encoding a second depth map into a second latent representation;
applying a second contextual embedding to the second latent representation to obtain a second contextualized latent representation;
decoding the second contextualized latent representation into a second contextualized depth map; and
generating a contextually consistent depth map based on a weighted sum of the contextualized depth map and the second contextualized depth map.

16. The method of claim 15, further comprising:
generating a weighting corresponding to the contextualized depth map based on a temporal context associated with the contextualized depth map; and
applying the weighting to the contextualized depth map.

17. The method of claim 15, further comprising:
generating a weighting corresponding to the contextualized depth map based on a spatial context associated with the contextualized depth map; and
applying the weighting to the contextualized depth map.

18. The method of claim 15, further comprising:
inputting the contextually consistent depth map and a corresponding input frame into a first machine learning model trained to generate a birds-eye-view representations of scenes; and
obtaining as output from the first machine learning model, based on the contextually consistent depth map, a birds-eye-view representation of a portion of a scene corresponding to the input frame.

19. The method of claim 14, wherein encoding the depth map comprises:
inputting the depth map into a first machine learning model trained to encode depth maps into latent representations; and
obtaining as output from the first machine learning model, based on the depth map, the latent representation.

20. The method of claim 19, wherein the first machine learning model includes a variational autoencoder.
